(19) United States
(12) Patent Application Publication
(10) Pub. No.: US 2025/0360830 A1
(43) Pub. Date: Nov. 27, 2025

(54) Electric Vehicle Charging Based on Charging Station Queue Management According to IoT Data Analysis

(71) Applicant: International Business Machines Corporation, Armonk, NY (US)

(72) Inventors: Su Liu, Austin, TX (US); Zhi Li Guan, Beijing (CN); Jennifer Sparks, Half Moon Bay, CA (US); Jun Su, Beijing (CN)

(21) Appl. No.: 18/672,429

(22) Filed: May 23, 2024

(51) Int. Cl. B60L 53/66; B60L 53/62; B60L 53/65; B60L 53/68

(52) U.S. Cl. CPC B60L 53/66; B60L 53/62; B60L 53/65; B60L 53/68; B60L 2240/72; B60L 2260/32

(57) ABSTRACT

Managing automated electric vehicle self-charging is provided. An identifier corresponding to an electric vehicle is placed in a queue of a charging station located in a geographic area surrounding a parking location of the electric vehicle based on a wait time for the electric vehicle at the charging station being within a maximum wait time defined by a user of the electric vehicle. A first set of instructions is deployed to the electric vehicle to self-drive from the parking location to the charging station to self-charge a battery in accordance with the wait time.

### BACKGROUND

The disclosure relates generally to electric vehicles and more specifically to charging electric vehicles.

Electric vehicles are vehicles that use one or more electric motors for propulsion. Typically, electric vehicles are powered by batteries, such as, for example, lithium-ion batteries. Lithium-ion batteries have higher energy density, longer life span, and higher power density than most other battery types. A charging station is a power supply device that supplies electrical power for recharging batteries of electric vehicles. Charging stations are commonly equipped with multiple connectors to be able to charge a wide variety of electric vehicles.

Generally, charging stations are located along road-sides, at shopping centers, grocery stores, restaurants, hotels, movie theaters, businesses, government facilities, parking lots, and the like. Electric vehicle chargers fall into three categories based on their charging speed: Level 1, Level 2, and Level 3. Level 1 chargers are 120-volt chargers that provide alternating current electricity to the vehicle and are the slowest type of chargers. Level 2 chargers are 240-volt chargers that also provide alternating current electricity to the vehicle and are faster than Level 1 chargers. Level 3 chargers are known as fast or rapid chargers providing direct current electricity to the vehicle and can charge a battery in about an hour.

### SUMMARY

According to one illustrative embodiment, a computer-implemented method for automated electric vehicle self-charging is provided. A computer places an identifier corresponding to an electric vehicle in a queue of a charging station located in a geographic area surrounding a parking location of the electric vehicle based on a wait time for the electric vehicle at the charging station being within a maximum wait time defined by a user of the electric vehicle. The computer deploys a first set of instructions to the electric vehicle to self-drive from the parking location to the charging station to self-charge a battery in accordance with the wait time. According to other illustrative embodiments, a computer system and computer program product for automated electric vehicle self-charging are provided.

### BRIEF DESCRIPTION OF THE DRAWINGS

FIG. 1 is a pictorial representation of a computing environment in which illustrative embodiments may be implemented;

FIG. 2 is a diagram illustrating an example of a smart electric vehicle charging and queue management system in accordance with an illustrative embodiment;

FIG. 3 is a diagram illustrating an example of an electric vehicle charging process in accordance with an illustrative embodiment;

FIG. 4 is a diagram illustrating an example of a data structure in accordance with an illustrative embodiment;

FIG. 5 is a diagram illustrating an example of an exemplary use case in accordance with an illustrative embodiment;

FIG. 6 is a diagram illustrating an example of another exemplary use case in accordance with an illustrative embodiment; and

FIGS. 7A-7B are a flowchart illustrating a process for managing automated electric vehicle self-charging in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

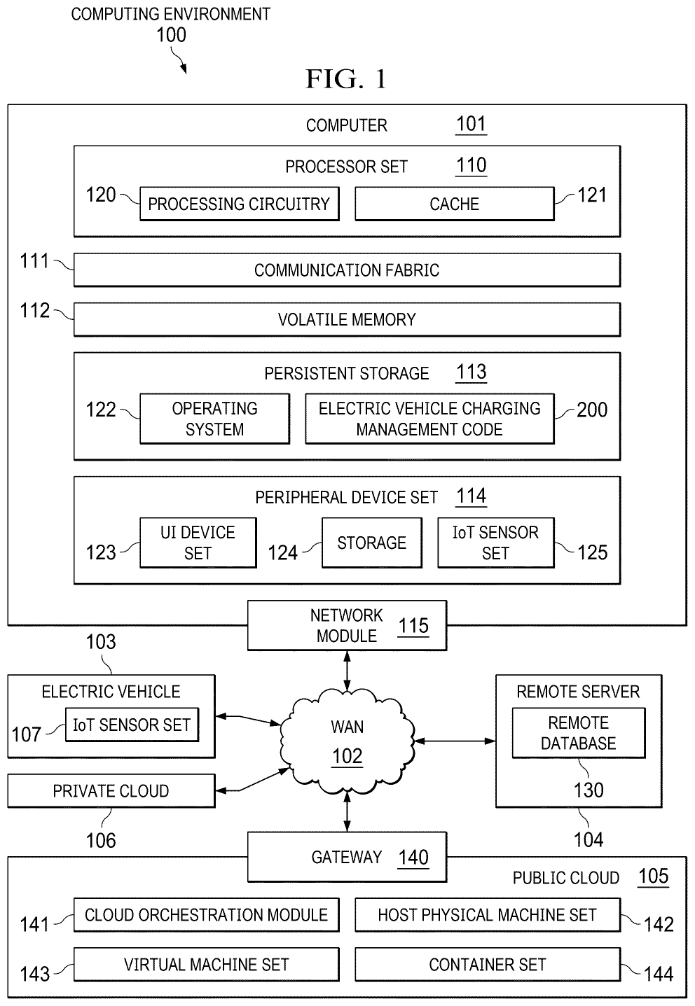

With reference now to the figures, and in particular, with reference to FIGS. 1-3, diagrams of data processing environments are provided in which illustrative embodiments may be implemented. It should be appreciated that FIGS. 1-3 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as electric vehicle charging management code 200. For example, electric vehicle charging management code 200 enables smart electric vehicle charging based on charging station queue management in accordance with Internet of Things (IoT) data analysis for automatically recharging a battery of an electric vehicle having a self-parking component. In other words, electric vehicle charging management code 200 intelligently registers an electric vehicle into a queue of an assigned charging station without user intervention. Furthermore, electric vehicle charging management code 200 predicts the charging needs of the electric vehicle and automatically deploys the electric vehicle to the assigned charging station to complete the charging procedure in accordance with the predicted charging needs of the electric vehicle and an estimated wait time at the charging station. It should be noted that electric vehicle charging management code 200 trains a set of machine learning models to perform the predictive analytics using historic electric vehicle charging data, enabling electric vehicle charging management code 200 to forecast electric vehicle charging needs, charging station demand, queue wait times, and optimal charging schedules. In addition, for real-time data processing and decision-making, electric vehicle charging management code 200 utilizes edge computing components (e.g., IoT devices) in proximity to charging stations to reduce latency and improve responsiveness.

In addition to electric vehicle charging management code 200, computing environment 100 includes, for example, computer 101, wide area network (WAN) 102, electric vehicle 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and electric vehicle charging management code 200, as identified above), peripheral device set 114 (including user interface (UI) device set 123 and storage 124), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in electric vehicle charging management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

Electric vehicle 103 can represent any type of electric vehicle controlled by a user (e.g., a subscriber of the electric vehicle charging management services provided by computer 101). Furthermore, electric vehicle 103 can represent a plurality of electric vehicles wirelessly connected to WAN 102. Electric vehicle 103 includes, for example, a rechargeable battery and a computer system. The computer system of electric vehicle 103 can include all or some of the components shown in connection with computer 101. Electric vehicle 103 also includes IoT sensor set 107. IoT sensor set 107 includes, for example, a global positioning system (GPS) sensor, light detection and ranging (LiDAR) sensor, imaging sensor (e.g., camera), ultrasonic sensor, battery charge sensor, and the like for detecting the surroundings, battery state of charge level, geographic location, and the like of electric vehicle 103.

Electric vehicle 103 receives helpful and useful data from the operations of computer 101. For example, in a hypothetical case where computer 101 is designed to provide an electric vehicle charging recommendation to the user of electric vehicle 103, this recommendation would typically be communicated from network module 115 of computer 101 through WAN 102 to electric vehicle 103. In this way, electric vehicle 103 can display, or otherwise present, the electric vehicle charging recommendation to the user.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide an electric vehicle charging recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The adoption of electric vehicles is steadily increasing due to environmental concerns, government incentives, and advancements in electric vehicle technology. As the number of electric vehicles grows, so does the need for electric vehicle charging infrastructure. However, this rapid growth in electric vehicles has brought about several challenges. For example, the lack of availability and accessibility of charging stations is an issue. Many areas are experiencing a shortage of charging infrastructure, leading to long queues and inconveniences for electric vehicle users. In addition, electric vehicle charging times can vary depending on the charging station's power level and the electric vehicle's battery capacity. Further, longer charging times further exacerbate queueing issues. Furthermore, electric vehicle users typically need to charge their electric vehicles based on the battery's state of charge. An electric vehicle with a near zero battery state of charge may have a higher priority for charging than another electric vehicle with a higher battery state of charge.

Currently, many electric vehicles are equipped with advanced technologies such as smart features. These smart features can include, for example, sensor and connectivity smart features. Smart sensor features can include, for example, GPS sensors, LiDAR sensors, imaging sensors, ultrasonic sensors, and the like. These smart sensor features enable data collection regarding the electric vehicle's surroundings, battery state of charge level, geographic location, and the like. Regarding smart connectivity features, electric vehicles can be connected to the Internet, allowing for real-time data transmission and remote communication with centralized data processing systems (e.g., servers). This connectivity enables remote diagnostics, over-the-air updates, and data analysis.

Internet of Things (IoT) involves the interconnection of various devices and systems via the Internet or other network, enabling data exchange and analysis for improved decision-making. IoT sensor networks can assist in managing electric vehicle charging and queueing. For example, IoT sensor networks can collect and process data from electric vehicles, charging stations, electrical grid, traffic services, and the like. This data can include, for example, real-time electric vehicle battery state of charge, charging station availability, traffic conditions, and the like. By analyzing historical and real-time electric vehicle charging data from IoT devices wirelessly connected to the network, illustrative embodiments using trained machine learning models can predict charging station utilization, wait times, and optimal charging schedules.

Illustrative embodiments provide queue management at electric vehicle charging stations. As the popularity of electric vehicles increases, queues at charging stations increase in size as well, causing inconvenience for electric vehicle users. Illustrative embodiments predict and manage these charging station queues effectively, reducing wait times and ensuring efficient use of charging stations. For example, illustrative embodiments analyze historic and real-time data, which includes battery state of charge, traffic conditions, charging station availability, and the like, to optimally schedule electric vehicle charging sessions. This minimizes the need for electric vehicle users to charge their electric vehicles when it is not needed, reducing queue size and congestion at charging stations.

Electric vehicle range anxiety (i.e., the fear of running out of battery charge before reaching a charging station) is a concern for many electric vehicle users. Illustrative embodiments mitigate electric vehicle range anxiety by ensuring that users have access to available charging stations when needed. By analyzing data from electric vehicles and charging stations within a defined geographic area, illustrative embodiments assist electric vehicle users to optimize the use of charging stations. This includes load balancing to prevent overloading of the electrical grid and ensuring that charging stations are optimally utilized. Illustrative embodiments increase user convenience by allowing electric vehicle users to remotely queue for charging at charging stations, set user preferences, and receive notifications regarding the electric vehicle's charging status. Thus, illustrative embodiments simplify the electric vehicle charging process.

Illustrative embodiments can also decrease energy costs for both electric vehicle users and charging station operators. By optimizing charging schedules for electric vehicles, illustrative embodiments can take advantage of off-peak electricity rates, saving money for users and promoting electrical grid stability. In addition, by reducing queues and congestion at charging stations and optimizing charging schedules for electric vehicles, illustrative embodiments can help to increase the adoption of electric vehicles, further reducing emissions from traditional gas-powered vehicles to decrease environmental impact by reducing reliance on fossil fuels. Furthermore, efficient queue management can help prevent long lines of waiting electric vehicles at charging stations, which can impact traffic flow. For example, illustrative embodiments can contribute to smoother traffic conditions and reduced congestion around electric vehicle charging station facilities.

IoT sensor data processing and analysis provides insights into electric vehicle usage patterns, charging station usage patterns, charging station performance patterns, and the like. This data-driven approach enables illustrative embodiments to make informed decisions regarding charging station availability and performance. Moreover, illustrative embodiments can increase safety by ensuring that electric vehicles navigate safely to charging stations and that charging sessions are secure and tamper-proof. Illustrative embodiments can also monitor the health of the electric vehicle's battery, promoting long-term battery safety.

Illustrative embodiments provide smart electric vehicle charging and queue management based on IoT sensor network data analysis for automatically recharging a battery of an electric vehicle with a self-parking assistant feature (e.g., a semiautonomous electric vehicle). Illustrative embodiments utilize a centralized server to perform the data analysis. Illustrative embodiments define a data structure to track, save, and process collected IoT sensor data. The collected data includes, for example, user identifiers, electric vehicle identifiers, electric vehicle battery state of charge levels, electric vehicle current geographic locations, current time, charging station identifiers, charge station geographic locations, charging station queue sizes, rankings of electric vehicles in charging station queues, electric vehicle estimated waiting times, payment information with account numbers corresponding to user identifiers, and the like.

Illustrative embodiment allow system administrators and users to configure and customize settings, rules, or criteria, such as, for example, an electric vehicle charging threshold (e.g., 20% battery state of charge, 50 miles to nearest charging station), maximum distance to self-drive to an assigned nearby charging station from a current parking lot location (e.g., only execute self-driving to perform self-charging if distance to assigned charging station is <300 yards from current parking location or parking space), maximum self-charging time, charging cost, electric vehicle charging options (e.g., standard or fast charging), and the like, contained in an electric vehicle charging service profile of settings and user profiles of user preferences. Illustrative embodiments monitor IoT sensors of an electric vehicle to collect IoT sensor data regarding electric vehicle battery state of charge level, nearby charging stations and their corresponding wait times, and the like. Illustrative embodiments also collect IoT sensor data from other electric vehicles in the geographic area regarding their respective electric vehicle battery state of charge level, their nearby charging stations and corresponding wait times, and the like.

Illustrative embodiments predict charging needs of the electric vehicle based on the current battery state of charge level. Illustrative embodiments identify the nearest charging station based on the current battery state of charge level of the electric vehicle. Illustrative embodiments also determine the availability and accessibility of the nearest charging station. Illustrative embodiments push a charging request corresponding to the electric vehicle into the queue of the charging station based on the determined availability of that charging station and estimated wait time in the queue.

Illustrative embodiments instruct the electric vehicle to self-drive to the assigned charging station for self-charging from a current parking location in accordance with the estimated wait time. Upon receiving an indication that charging of the battery of the electric vehicle is completed, illustrative embodiments pay the cost of charging the electric vehicle and any related fees using account information contained in a user profile corresponding to the user of the electric vehicle. Moreover, illustrative embodiments instruct the electric vehicle to self-drive back to the original parking location from the charging station.

Thus, illustrative embodiments decrease the need for physical user presence at charging stations based on remote charging station queuing, user preference settings, electric vehicle self-driving and self-charging capabilities, and monitoring of the electric vehicle charging process. In addition, illustrative embodiments can minimize charging during peak hours for electric vehicle users to take advantage of off-peak electricity rates. Moreover, illustrative embodiments minimize user frustration that is often associated with long queues and uncertainty about charging availability, improving the electric vehicle user experience.

As a result, illustrative embodiments provide one or more technical solutions that overcome a technical problem with a current inability to automatically recharge an electric vehicle based on IoT sensor data analysis and charging station queue management. As a result, these one or more technical solutions provide a technical effect and practical application in the field of electric vehicles.

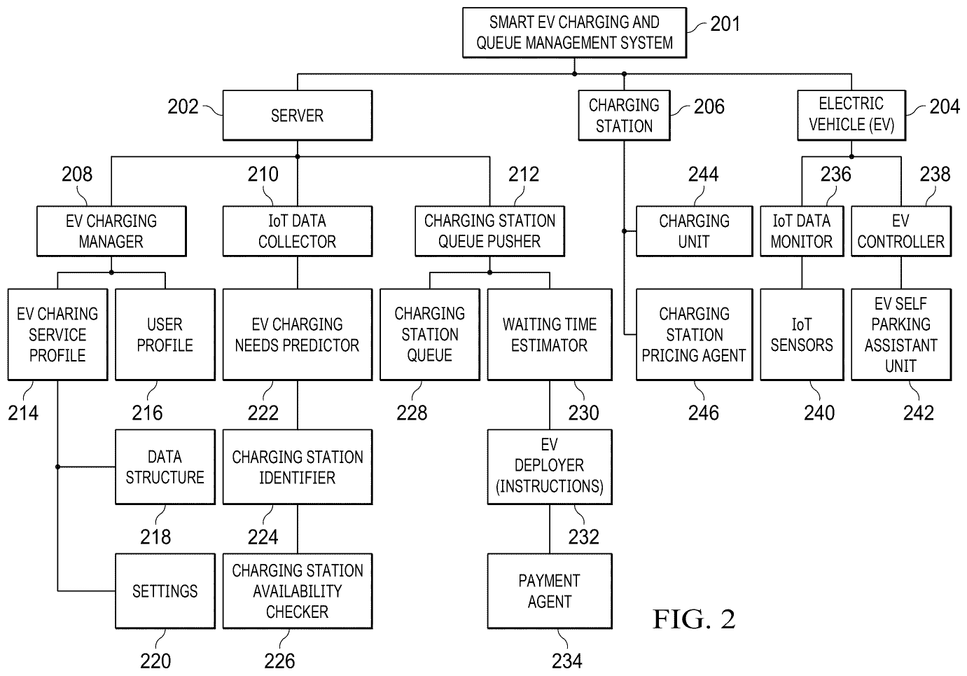

With reference now to FIG. 2, a diagram illustrating an example of a smart electric vehicle charging and queue management system is depicted in accordance with an illustrative embodiment. Smart electric vehicle charging and queue management system 201 may be implemented in a computing environment, such as computing environment 100 in FIG. 1. Smart electric vehicle charging and queue management system 201 is a system of hardware and software components for smart electric vehicle charging and charging station queue management based on IoT sensor data analysis for automatic self-charging of a battery of an electric vehicle with a self-parking feature.

In this example, smart electric vehicle charging and queue management system 201 includes server 202, electric vehicle (EV) 204, and charging station 206. However, it should be noted that smart electric vehicle charging and queue management system 201 is intended to be an example only and not as a limitation on illustrative embodiments. For example, smart electric vehicle charging and queue management system 201 can include any number of servers, electric vehicles, charging stations, and other devices and components not shown.

Server 202 can be, for example, computer 101 in FIG. 1. Server 202 includes a plurality of components, such as, for example, EV charging manager 208, IoT data collector 210, and charging station queue pusher 212. Server 202 utilizes EV charging manager 208 to control the process of automatically charging electric vehicles, such as electric vehicle 204, at charging stations, such as charging station 206. Server 202 utilizes IoT data collector 210 to collect IoT sensor data from a network of IoT sensors associated with, for example, electric vehicle 204, charging station 206, traffic cameras, electrical power grid meters, and the like. Server 202 utilizes charging station queue pusher 212 to place identifiers corresponding to electric vehicles, such as electric vehicle 204, in queues corresponding to charging stations, such as charging station 206.

EV charging manager 208 may be implemented by electric vehicle charging management code 200 in FIG. 1. EV charging manager 208 includes EV charging service profile 214 and user profile 216. EV charging service profile 214 contains data structure 218 and settings 220. Data structure 218 includes, for example, user identifiers, electric vehicle identifiers, battery state of charge levels of electric vehicles, current locations of electric vehicles, charging station identifiers, charging station locations, charging station queues, estimated waiting times at charging stations, payment information, and the like. Settings 220 include, for example, electric vehicle charging thresholds, maximum electric vehicle self-driving distances, electric vehicle battery capacities, and the like. Setting 220 can be defined by, for example, system administrators, electric vehicle manufacturers, electric vehicle users, and the like. User profile 216 corresponds to a user of electric vehicle 204 in this example. However, it should be noted that user profile 216 can represent a plurality of different user profiles associated with a plurality of different electric vehicle users. User profile 216 contains, for example, user preferences regarding electric vehicle charging, such as maximum wait time in a charging station queue to start electric vehicle charging, maximum time to complete electric vehicle charging, type of charging (e.g., standard charging or fast charging), maximum cost for charging, account information for payment of charging costs, and the like.

Server 202 utilizes EV charging needs predictor 222 to predict the charging needs of electric vehicles, such as electric vehicle 204, based on IoT sensor data collected by IoT data collector 210 from IoT sensors corresponding to the electric vehicles. Server 202 utilizes charging station identifier 224 to identify charging stations, such as charging station 206, within different geographic regions where electric vehicles can recharge their batteries. Charging station identifier 224 utilizes charging station availability checker 226 to determine the availability of each identified charging station for recharging electric vehicle batteries based on IoT sensor data collected by IoT data collector 210 from each identified charging station.

Charging station queue 228 represents the queue for charging station 206 in this example. In this example, charging station queue pusher 212 places the identifier for electric vehicle 204 in charging station queue 228, which corresponds to charging station 206. However, it should be noted that charging station queue 228 can represent a plurality of different queues corresponding to a plurality of different charging stations.

Charging station queue pusher 212 utilizes waiting time estimator 230 to estimate the time electric vehicles, such as electric vehicle 204, will have to wait in a charging station queue, such as charging station queue 228, prior to being deployed for charging. Server 202 utilizes EV deployer 232 to send instructions to electric vehicles, such as electric vehicle 204, to self-drive to assigned charging stations, such as charging station 206, to self-charge based on the estimated wait time generated by waiting time estimator 230 for each respective electric vehicle. Server 202 utilizes payment agent 234 to pay the cost of charging a particular electric vehicle, such as electric vehicle 204, at a given charging station, such as charging station 206, using account information contained in user profile 216.

Electric vehicle 204 includes a plurality of components, such as, for example, IoT data monitor 236 and EV controller 238. Electric vehicle 204 utilizes IoT data monitor 236 to monitor the IoT sensor data generated by IoT sensors 240. IoT sensors 240 represent a set of IoT sensors, such as, for example, a battery state of charge sensor, GPS sensor, LiDAR sensor, imaging sensor, and the like. IoT data monitor 236 sends all or a portion of the monitored IoT sensor data to IoT data collector 210 for processing and analysis.

Electric vehicle 204 utilizes EV controller 238 to control autonomous movements of electric vehicle 204 without user intervention. For example, EV controller 238 utilizes EV self-parking assistant unit 242 to self-drive electric vehicle 204 from a parking location to charging station 206 to self-charge in response to receiving instructions from EV deployer 232 to go to charging station 206. Afterward, EV controller 238 utilizes EV self-parking assistant unit 242 to self-drive electric vehicle 204 from charging station 206 back to the parking location after charging is completed in response to receiving instructions from EV deployer 232 to go back to the parking location.

Charging station 206 includes charging unit 244 and charging station pricing agent 246. Charging station 206 utilizes charging unit 244 to charge electric vehicle 204. Charging station 206 utilizes charging station pricing agent 246 to determine the cost for charging electric vehicle 204 based on factors, such as, for example, time of charging (e.g., peak or non-peak electrical grid usage hours), type of charging (e.g., standard or fast charging), charging station availability (e.g., queue size), and the like. After charging station pricing agent 246 determines the cost for charging electric vehicle 204, charging station pricing agent 246 sends the cost to payment agent 234 of server 202 for payment of the cost.

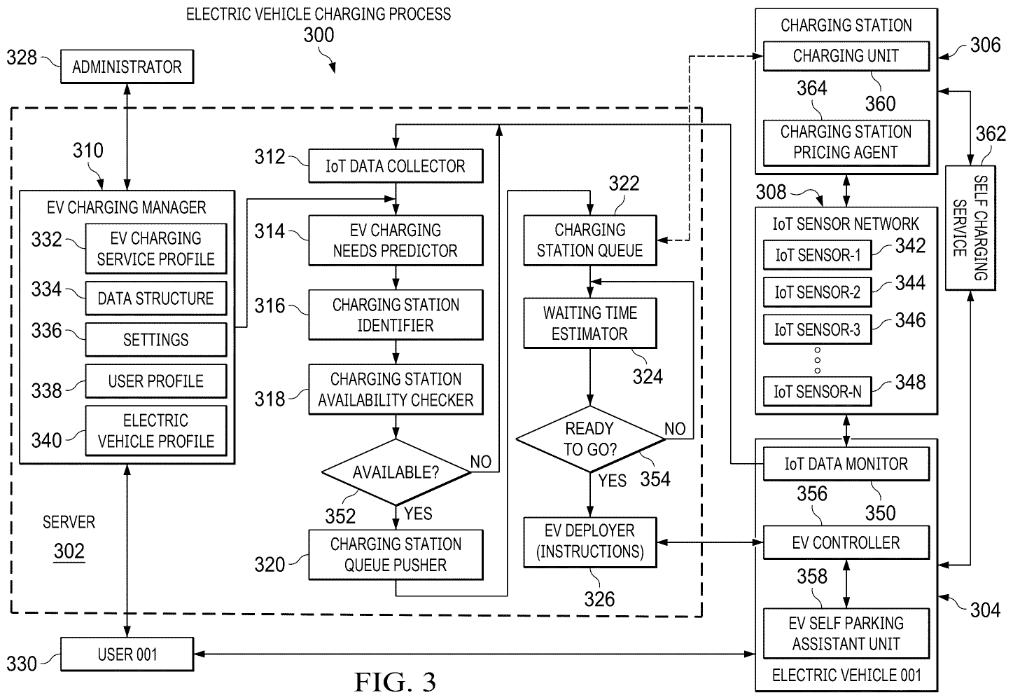

With reference now to FIG. 3, a diagram illustrating an example of an electric vehicle charging process is depicted in accordance with an illustrative embodiment. Electric vehicle charging process 300 can be implemented in smart electric vehicle charging and queue management system 201 in FIG. 2.

In this example, electric vehicle charging process 300 includes server 302, electric vehicle-001 304, charging station 306, and IoT sensor network 308. Server 302, electric vehicle-001 304, and charging station 306 can be, for example, server 202, electric vehicle 204, and charging station 206 in FIG. 2. However, it should be noted that electric vehicle charging process 300 can include any number of servers, electric vehicles, and charging stations.

Server 302 includes EV charging manager 310, IoT data collector 312, EV charging needs predictor 314, charging station identifier 316, charging station availability checker 318, charging station queue pusher 320, charging station queue 322, waiting time estimator 324, and EV deployer 326. It should be noted that EV charging manager 310, IoT data collector 312, EV charging needs predictor 314, charging station identifier 316, charging station availability checker 318, charging station queue pusher 320, charging station queue 322, waiting time estimator 324, and EV deployer 326 are the same as and have the same functionality as EV charging manager 208, IoT data collector 210, EV charging needs predictor 222, charging station identifier 224, charging station availability checker 226, charging station queue pusher 212, charging station queue 228, waiting time estimator 230, and EV deployer 232 in FIG. 2.

Administrator 328 and user-001 330 input and customize as needed EV charging service profile 332, data structure 334, settings 336, user profile 338, and electric vehicle profile 340 in EV charging manager 310. EV charging service profile 332, data structure 334, settings 336, and user profile 338 are the same as and contain the same information as EV charging service profile 214, data structure 218, settings 220, and user profile 216 in FIG. 2. Electric vehicle profile 340 contains, for example, specification data such as battery capacity corresponding to electric vehicle-001 304.

IoT sensor network 308 includes IoT sensor-1 342, IoT sensor-2 344, IoT sensor-3 346, to IoT sensor-N 348. At least one of IoT sensor-1 342, IoT sensor-2 344, IoT sensor-3 346, and IoT sensor-N 348 are located in electric vehicle-001 304 (e.g., IoT sensors 240 in FIG. 2), on charging station 306, around parking lots, along roadways, and the like.

IoT data monitor 350 monitors the IoT sensor data generated by IoT sensor network 308 and sends the IoT sensor data to IoT data collector 312 for processing and analysis by EV charging needs predictor 314 and charging station availability checker 318. At 352, charging station availability checker 318 determines whether charging station 306 is available based on EV charging needs predictor 314 determining that electric vehicle-001 304 needs charging.

In response to charging station availability checker 318 determining that charging station 306 is available, charging station queue pusher 320 inserts electric vehicle-001 304 into charging station queue 322, which corresponds to charging station 306. At 354, waiting time estimator 324 determines whether charging station 306 is ready for electric vehicle-001 304 to go to charging station 306 for charging.

In response to waiting time estimator 324 determining that charging station 306 is ready for electric vehicle-001 304, EV deployer 326 deploys instructions to EV controller 356 to go to charging station 306 for charging. In response to receiving the instructions, EV controller 356 utilizes EV self-parking assistant unit 358 to self-drive to charging station 306 and connect to charging unit 360 to self-charge using self-charging service 362. When charging of electric vehicle-001 304 is completed, charging station pricing agent 364 determines that cost of charging electric vehicle-001 304.

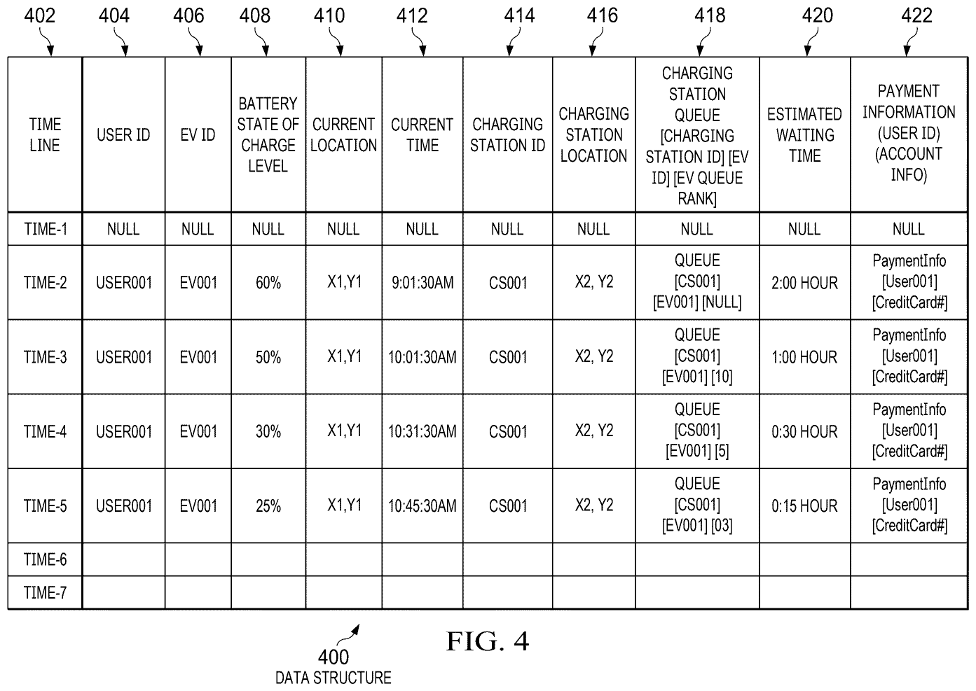

With reference now to FIG. 4, a diagram illustrating an example of a data structure is depicted in accordance with an illustrative embodiment. Data structure 400 can be, for example, data structure 218 of server 202 in FIG. 2 or data structure 334 of server 302 in FIG. 3. In this example, data structure 400 includes timeline 402, user identifier (ID) 404, electric vehicle (EV) ID 406, battery state of charge level 408, current location 410, current time 412, charging station ID 414, charging station location 416, charging station queue 418, estimated waiting time 420, and payment information 422.

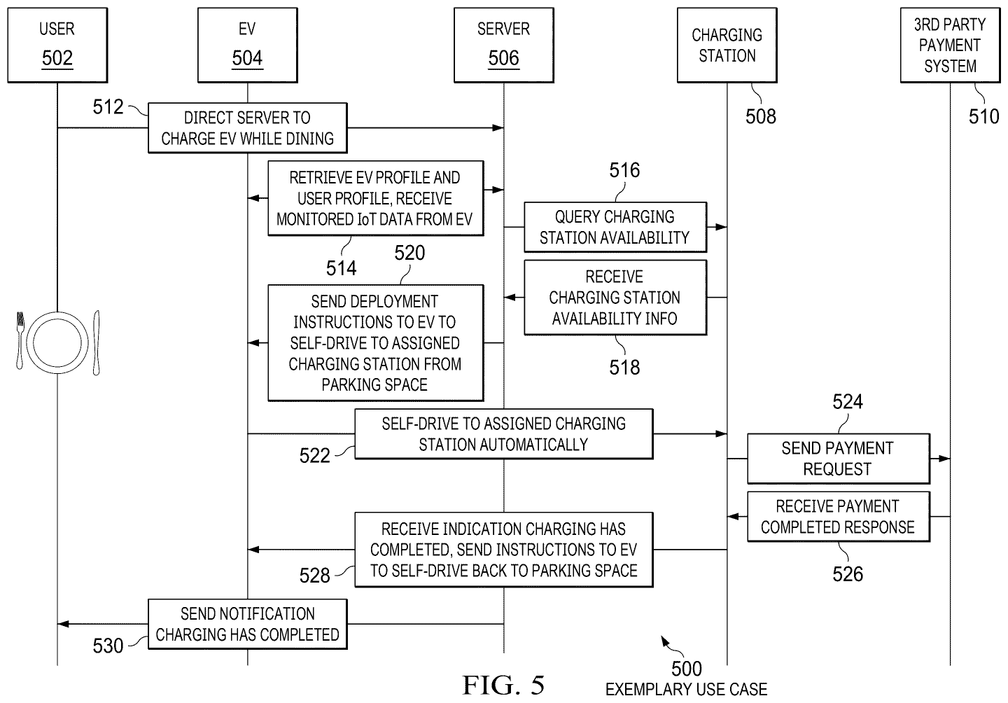

With reference now to FIG. 5, a diagram illustrating an example of an exemplary use case is depicted in accordance with an illustrative embodiment. Exemplary use case 500 can be implemented in smart electric vehicle charging and queue management system 201.

In this example, exemplary use case 500 includes user 502, electric vehicle 504, server 506, charging station 508, and third-party payment system 510. At 512, user 502 directs server 506 to charge electric vehicle 504 while user 502 is dining at a restaurant, for example.

At 514, in response to server 506 receiving the direction to charge electric vehicle 504 while user 502 is dining, server 506 retrieves an electric vehicle profile, such as, for example, electric vehicle profile 340 in FIG. 3, corresponding to electric vehicle 504 and a user profile, such as, for example, user profile 338 in FIG. 3, corresponding to user 502. In addition, server 506 receives monitored IoT sensor data from electric vehicle 504 indicating a current battery state of charge of electric vehicle 504.

Further, at 516, server 506 queries charging station 508 for availability of charging station 508. Charging station 508 may be located, for example, in the parking lot of the restaurant where user 502 is dining. Afterward, at 518, server 506 receives availability information from charging station 508.

At 520, based on the availability information received from charging station 508, server 506 sends deployment instructions to electric vehicle 504 to self-drive to charging station 508 from a parking space in the parking lot where electric vehicle 504 is currently parked. At 522, in response to receiving the deployment instructions from server 506, electric vehicle 504 self-drives to charging station 508 automatically using a self-parking feature, such as, for example, EV self-parking assistant unit 358 in FIG. 3.

At 524, when charging station 508 completes charging of electric vehicle 504, charging station 508 sends a payment request to third-party payment system 510 to pay the cost of charging electric vehicle 504. Third-party payment system 510 may be associated with, for example, a credit card company, bank, or the like. Alternatively, charging station 508 can send the payment request to server 506 for processing and payment. At 526, charging station 508 receives a payment completed response from third-party payment system 510.

At 528, server 506 receives an indication that charging of electric vehicle 504 is completed and sends instructions to electric vehicle 504 to self-drive back to the original parking space in the parking lot from charging station 508. At 530, server 506 also sends a notification to user 502 that charging of electric vehicle 504 is completed.

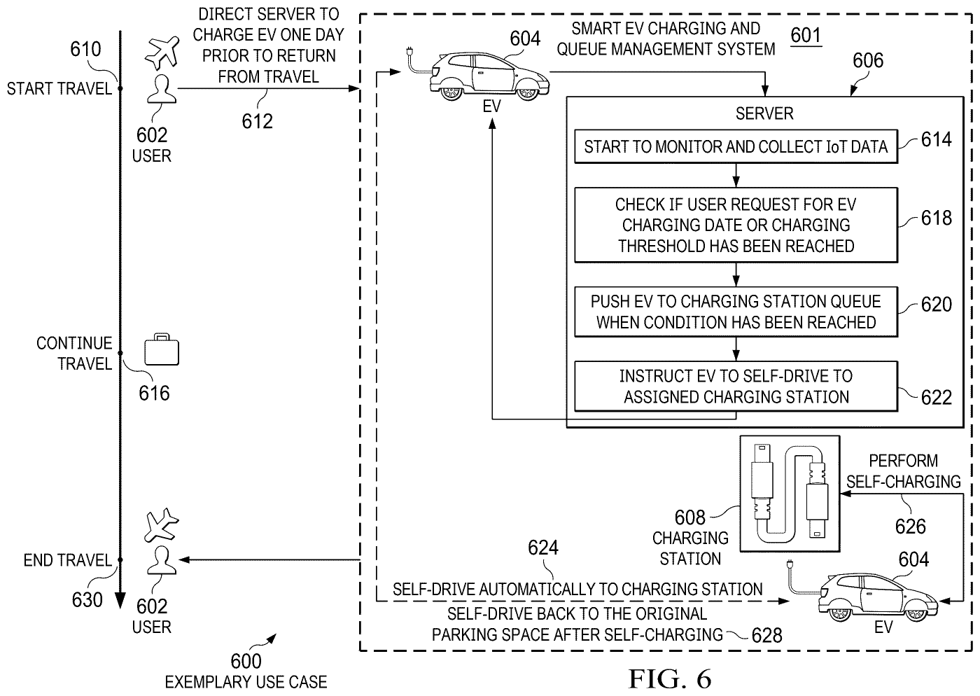

With reference now to FIG. 6, a diagram illustrating an example of another exemplary use case is depicted in accordance with an illustrative embodiment. Exemplary use case 600 is implemented in smart electric vehicle charging and queue management system 601, such as, for example, smart electric vehicle charging and queue management system 201 in FIG. 2.

In this example, exemplary use case 600 includes user 602, electric vehicle 604, server 606, and charging station 608. At 610, user 602 starts travel plans at an airport. At 612, user 602 directs server 606 to charge electric vehicle 604 one day prior to user 602 returning from traveling. It should be noted that user 602 drove electric vehicle 604 to the airport and parked electric vehicle 604 in a parking lot of the airport. In addition, charging station 608 is located in or near the parking lot where electric vehicle 604 is currently parked.

At 614, in response to receiving the direction to charge electric vehicle 604, server 606 starts to monitor and collect IoT sensor data, which includes, for example, battery state of charge, geographic location, and the like, from electric vehicle 604. At 616, user 602 continues traveling. At 618, server 606 checks if user 602's requested electric vehicle charging date has been reached or a battery charging threshold (e.g., battery state of charge is <25%) has been reached.

At 620, server 606 inserts electric vehicle 604 into the queue of charging station 608 when one of the conditions at 618 above has been reached. Moreover, at 622, server 606 instructs electric vehicle 604 to self-drive to charging station 608.

At 624, electric vehicle 604 automatically self-drives to charging station 608 in response to receiving the instructions from server 606. At 626, electric vehicle 604 performs self-charging at charging station 608. When charging station 608 completes charging of electric vehicle 604, charging station 608 sends a charging completed indication to server 606.

After receiving the charging completed indication from charging station 608, server 606 instructs electric vehicle 604 to self-drive back to the original parking space in the parking lot from charging station 608. At 628, electric vehicle 604 self-drives back to the original parking space in the parking lot from charging station 608 after self-charging. At 630, user 602 ends travel and is able to drive an already charged electric vehicle 604 from the airport.

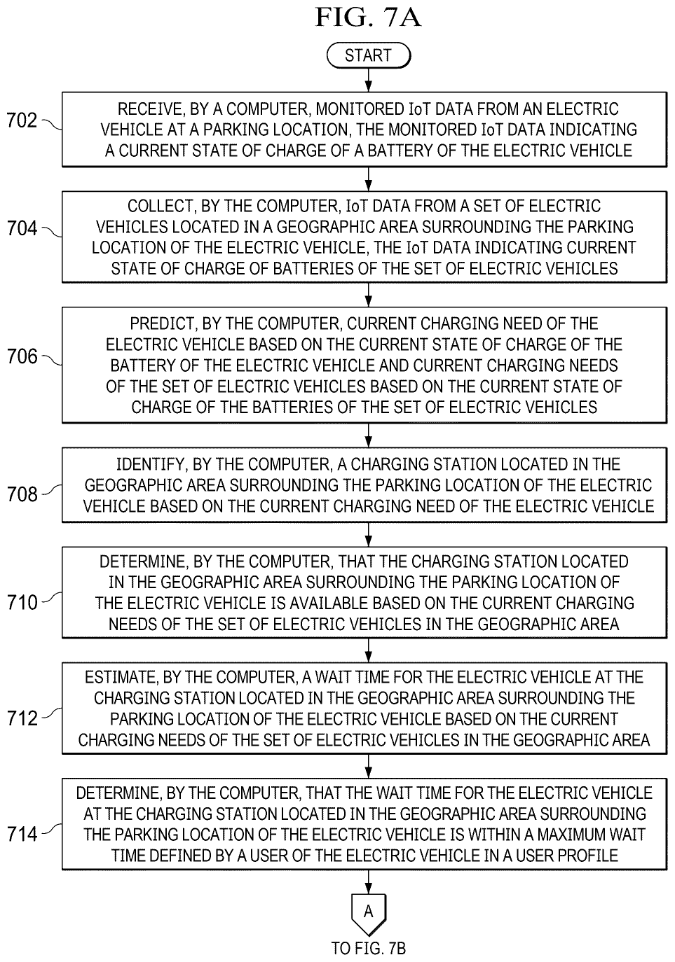

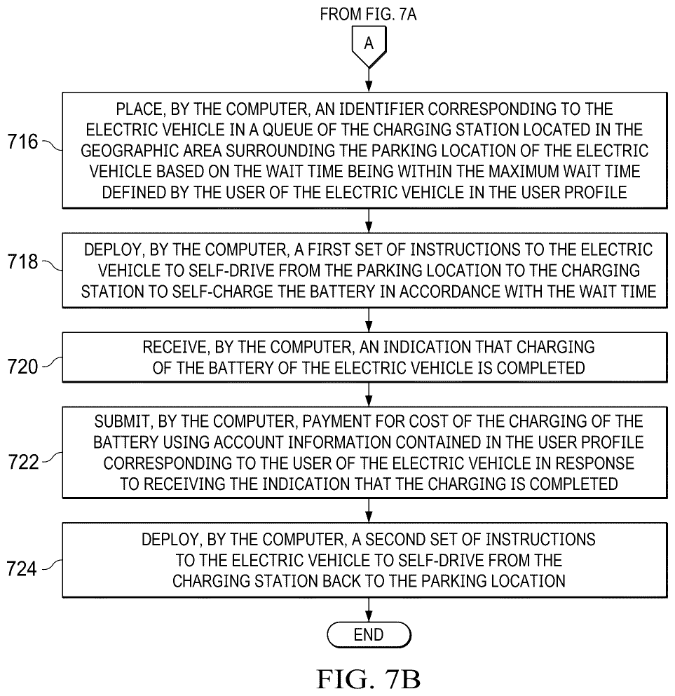

With reference now to FIGS. 7A-7B, a flowchart illustrating a process for managing automated electric vehicle self-charging is shown in accordance with an illustrative embodiment. The process shown in FIGS. 7A-7B may be implemented in a computer, such as, for example, computer 101 in FIG. 1 or server 302 in FIG. 3. For example, the process shown in FIGS. 7A-7B may be implemented by electric vehicle charging management code 200 in FIG. 1.

The process begins when the computer receive monitored IoT data from an electric vehicle at a parking location (step 702). The monitored IoT data indicates a current state of charge of a battery of the electric vehicle. In addition, the computer collects IoT data from a set of electric vehicles located in a geographic area surrounding the parking location of the electric vehicle (step 704). The IoT data indicates current state of charge of batteries of the set of electric vehicles.

The computer predicts current charging need of the electric vehicle based on the current state of charge of the battery of the electric vehicle and current charging needs of the set of electric vehicles based on the current state of charge of the batteries of the set of electric vehicles (step 706). Further, the computer identifies a charging station located in the geographic area surrounding the parking location of the electric vehicle based on the current charging need of the electric vehicle (step 708). Furthermore, the computer determines that the charging station located in the geographic area surrounding the parking location of the electric vehicle is available based on the current charging needs of the set of electric vehicles in the geographic area (step 710).

The computer estimates a wait time for the electric vehicle at the charging station located in the geographic area surrounding the parking location of the electric vehicle based on the current charging needs of the set of electric vehicles in the geographic area (step 712). The computer determines that the wait time for the electric vehicle at the charging station located in the geographic area surrounding the parking location of the electric vehicle is within a maximum wait time defined by a user of the electric vehicle in a user profile (step 714). The computer places an identifier corresponding to the electric vehicle in a queue of the charging station located in the geographic area surrounding the parking location of the electric vehicle based on the wait time being within the maximum wait time defined by the user of the electric vehicle in the user profile (step 716).

Subsequently, the computer deploys a first set of instructions to the electric vehicle to self-drive from the parking location to the charging station to self-charge the battery in accordance with the wait time (step 718). The computer receives an indication that charging of the battery of the electric vehicle is completed (step 720). The computer submits payment for cost of the charging of the battery using account information contained in the user profile corresponding to the user of the electric vehicle in response to receiving the indication that the charging is completed (step 722). In addition, the computer deploys a second set of instructions to the electric vehicle to self-drive from the charging station back to the parking location (step 724). Thereafter, the process terminates.

Thus, illustrative embodiments of the present disclosure provide a computer-implemented method, computer system, and computer program product for smart electric vehicle charging and charging station queue management based on IoT data analysis for automatic self-charging of a battery of an electric vehicle with a self-parking feature. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for managing automated electric vehicle self-charging, the computer-implemented method comprising:
placing, by a computer, an identifier corresponding to an electric vehicle in a queue of a charging station located in a geographic area surrounding a parking location of the electric vehicle based on a wait time for the electric vehicle at the charging station being within a maximum wait time defined by a user of the electric vehicle; and
deploying, by the computer, a first set of instructions to the electric vehicle to self-drive from the parking location to the charging station to self-charge a battery in accordance with the wait time.

2. The computer-implemented method of claim 1, further comprising:
receiving, by the computer, an indication that charging of the battery of the electric vehicle is completed; and
deploying, by the computer, a second set of instructions to the electric vehicle to self-drive from the charging station back to the parking location.

3. The computer-implemented method of claim 1, further comprising:
receiving, by the computer, monitored IoT data from the electric vehicle at the parking location, the monitored IoT data indicating a current state of charge of the battery of the electric vehicle; and
collecting, by the computer, IoT data from a set of electric vehicles located in the geographic area surrounding the parking location of the electric vehicle, the IoT data indicating current state of charge of batteries of the set of electric vehicles.

4. The computer-implemented method of claim 3, further comprising:
predicting, by the computer, current charging need of the electric vehicle based on the current state of charge of the battery of the electric vehicle and current charging needs of the set of electric vehicles based on the current state of charge of the batteries of the set of electric vehicles.

5. The computer-implemented method of claim 4, further comprising:
identifying, by the computer, the charging station located in the geographic area surrounding the parking location of the electric vehicle based on the current charging need of the electric vehicle; and
determining, by the computer, that the charging station located in the geographic area surrounding the parking location of the electric vehicle is available based on the current charging needs of the set of electric vehicles in the geographic area.

6. The computer-implemented method of claim 4, further comprising:
estimating, by the computer, the wait time for the electric vehicle at the charging station located in the geographic area surrounding the parking location of the electric vehicle based on the current charging needs of the set of electric vehicles in the geographic area; and
determining, by the computer, that the wait time for the electric vehicle at the charging station located in the geographic area surrounding the parking location of the electric vehicle is within the maximum wait time defined by the user of the electric vehicle in a user profile.

7. The computer-implemented method of claim 1, further comprising:
submitting, by the computer, payment for cost of charging the battery using account information contained in a user profile corresponding to the user of the electric vehicle in response to receiving an indication that the charging is completed.

8. A computer system for managing automated electric vehicle self-charging, the computer system comprising:
a communication fabric;
a set of computer-readable storage media connected to the communication fabric, wherein the set of computer-readable storage media collectively stores program instructions; and
a set of processors connected to the communication fabric, wherein the set of processors executes the program instructions to:
place an identifier corresponding to an electric vehicle in a queue of a charging station located in a geographic area surrounding a parking location of the electric vehicle based on a wait time for the electric vehicle at the charging station being within a maximum wait time defined by a user of the electric vehicle; and
deploy a first set of instructions to the electric vehicle to self-drive from the parking location to the charging station to self-charge a battery in accordance with the wait time.

9. The computer system of claim 8, wherein the set of processors further executes the program instructions to:
receive an indication that charging of the battery of the electric vehicle is completed; and
deploy a second set of instructions to the electric vehicle to self-drive from the charging station back to the parking location.

10. The computer system of claim 8, wherein the set of processors further executes the program instructions to:
receive monitored IoT data from the electric vehicle at the parking location, the monitored IoT data indicating a current state of charge of the battery of the electric vehicle; and
collect IoT data from a set of electric vehicles located in the geographic area surrounding the parking location of the electric vehicle, the IoT data indicating current state of charge of batteries of the set of electric vehicles.

11. The computer system of claim 10, wherein the set of processors further executes the program instructions to:
predict current charging need of the electric vehicle based on the current state of charge of the battery of the electric vehicle and current charging needs of the set of electric vehicles based on the current state of charge of the batteries of the set of electric vehicles.

12. The computer system of claim 11, wherein the set of processors further executes the program instructions to:
identify the charging station located in the geographic area surrounding the parking location of the electric vehicle based on the current charging need of the electric vehicle; and
determine that the charging station located in the geographic area surrounding the parking location of the electric vehicle is available based on the current charging needs of the set of electric vehicles in the geographic area.

13. The computer system of claim 11, wherein the set of processors further executes the program instructions to:
estimate the wait time for the electric vehicle at the charging station located in the geographic area surrounding the parking location of the electric vehicle based on the current charging needs of the set of electric vehicles in the geographic area; and
determine that the wait time for the electric vehicle at the charging station located in the geographic area surrounding the parking location of the electric vehicle is within the maximum wait time defined by the user of the electric vehicle in a user profile.

14. A computer program product for managing automated electric vehicle self-charging, the computer program product comprising a set of computer-readable storage media having program instructions collectively stored therein, the program instructions executable by a computer to cause the computer to:
place an identifier corresponding to an electric vehicle in a queue of a charging station located in a geographic area surrounding a parking location of the electric vehicle based on a wait time for the electric vehicle at the charging station being within a maximum wait time defined by a user of the electric vehicle; and
deploy a first set of instructions to the electric vehicle to self-drive from the parking location to the charging station to self-charge a battery in accordance with the wait time.

15. The computer program product of claim 14, wherein the program instructions further cause the computer to:
receive an indication that charging of the battery of the electric vehicle is completed; and
deploy a second set of instructions to the electric vehicle to self-drive from the charging station back to the parking location.

16. The computer program product of claim 14, wherein the program instructions further cause the computer to:
receive monitored IoT data from the electric vehicle at the parking location, the monitored IoT data indicating a current state of charge of the battery of the electric vehicle; and
collect IoT data from a set of electric vehicles located in the geographic area surrounding the parking location of the electric vehicle, the IoT data indicating current state of charge of batteries of the set of electric vehicles.

17. The computer program product of claim 16, wherein the program instructions further cause the computer to:
predict current charging need of the electric vehicle based on the current state of charge of the battery of the electric vehicle and current charging needs of the set of electric vehicles based on the current state of charge of the batteries of the set of electric vehicles.

18. The computer program product of claim 17, wherein the program instructions further cause the computer to:
identify the charging station located in the geographic area surrounding the parking location of the electric vehicle based on the current charging need of the electric vehicle; and
determine that the charging station located in the geographic area surrounding the parking location of the electric vehicle is available based on the current charging needs of the set of electric vehicles in the geographic area.

19. The computer program product of claim 17, wherein the program instructions further cause the computer to:
estimate the wait time for the electric vehicle at the charging station located in the geographic area surrounding the parking location of the electric vehicle based on the current charging needs of the set of electric vehicles in the geographic area; and
determine that the wait time for the electric vehicle at the charging station located in the geographic area surrounding the parking location of the electric vehicle is within the maximum wait time defined by the user of the electric vehicle in a user profile.

20. The computer program product of claim 14, wherein the program instructions further cause the computer to:
submit payment for cost of charging the battery using account information contained in a user profile corresponding to the user of the electric vehicle in response to receiving an indication that the charging is completed.
